(19) United States
(12) Patent Application Publication
(10) Pub. No.: US 2025/0112479 A1
(43) Pub. Date: Apr. 3, 2025

(54) CHARGER FOR AEROSOL-GENERATING DEVICE WITH SPHERICAL COVER

(71) Applicant: Philip Morris Products S.A., Neuchatel (CH)

(72) Inventor: Matteo BOLOGNA, Lausanne (CH)

(73) Assignee: Philip Morris Products S.A., Neuchatel (CH)

(21) Appl. No.: 18/725,888

(22) PCT Filed: Jan. 5, 2023
(86) PCT No.: PCT/EP2023/050141

§ 371 Date: Jul. 1, 2024

(30) Foreign Application Priority Data
Jan. 5, 2022 (EP) 22150355.0

(51) Int. Cl. H02J 7/00; A24F 40/95

(52) U.S. Cl. CPC H02J 7/0044; A24F 40/95

(57) ABSTRACT

A mobile charger for an aerosol-generating device is provided, including: a cavity to receive the device; a charger power supply to recharge the device when the device is received in the cavity; and a cover to hold the device in the cavity when the device is received in the cavity, the cover being at least partly spherical, having an opening dimensioned such that the device fits through the opening, being rotatable between a first position and a second position, and the opening being aligned with a longitudinal axis of the cavity in the first position of the cover, and the device being held in the cavity when the device is received in the cavity and when the holder is in the second position.

The present invention relates to a charger for an aerosol-generating device. The invention further relates to a system and an aerosol-generating system.

It is known to provide an aerosol-generating device for generating an inhalable vapor. Such devices may heat aerosol-forming substrate to a temperature at which one or more components of the aerosol-forming substrate are volatilised without burning the aerosol-forming substrate. Aerosol-forming substrate may be provided as part of an aerosol-generating article. A heating element may be provided for heating the aerosol-forming substrate. The heating element is powered by a device battery. In some devices, the device battery only has a capacity for around 6 to 10 puffs of the aerosol-generating device. After that, the device battery has to be recharged. Mobile chargers are used for this purpose. The charger is dimensioned such that the aerosol-generating device can be inserted into the charger. The charger comprises a charger battery. The charger battery has a capacity that is significantly larger than the device battery. The charger battery in configured to charge the device battery.

It would be desirable to have a mobile charger for an aerosol-generating device in which the aerosol-generating device can he held securely. It would be desirable to have a mobile charger for an aerosol-generating device with improved charging of the aerosol-generating device. It would be desirable to have a mobile charger for an aerosol-generating device with an improved electrical connection between the mobile charger and the aerosol-generating device.

According to an embodiment of the invention there is provided a mobile charger for an aerosol-generating device. The mobile charger may comprise a cavity for receiving the aerosol-generating device. The mobile charger may further comprise a charger power supply for recharging the aerosol-generating device, when the aerosol-generating device is received in the cavity. The mobile charger may further comprise a cover for holding the aerosol-generating device in the cavity, when the aerosol-generating device is received in the cavity. The cover may at least be partly spherical. The cover may have an opening. The opening may be dimensioned such that the aerosol-generating device fits through the opening. The cover may be rotatable between a first position and a second position. The opening may be aligned with a longitudinal axis of the cavity in the first position of the cover. The aerosol-generating device may be held in the cavity when the aerosol-generating device is received in the cavity and when the holder is in the second position.

According to an embodiment of the invention there is provided a mobile charger for an aerosol-generating device. The mobile charger comprises a cavity for receiving the aerosol-generating device. The mobile charger further comprises a charger power supply for recharging the aerosol-generating device, when the aerosol-generating device is received in the cavity. The mobile charger further comprises a cover for holding the aerosol-generating device in the cavity, when the aerosol-generating device is received in the cavity. The cover is at least partly spherical. The cover has an opening. The opening is dimensioned such that the aerosol-generating device fits through the opening. The cover is rotatable between a first position and a second position. The opening is aligned with a longitudinal axis of the cavity in the first position of the cover. The aerosol-generating device is held in the cavity when the aerosol-generating device is received in the cavity and when the holder is in the second position.

By providing the rotatable cover, the aerosol-generating device can be easily inserted into the cavity of the charger in the first position of the cover. After rotation of the rotatable cover, the aerosol-generating device is securely held within the cavity in the second position of the cover. The electrical connection between the aerosol-generating device and the charger may be improved by the cover securely holding the aerosol-generating device in the cavity of the charger. Hence, security of recharging the aerosol-generating device by the charger may be improved.

By providing the charger as a mobile charger, the charger becomes portable. The charger may be dimensioned such that the charger can be transported easily, exemplarily in a bag or pocket of the user. In other words, the mobile charger is preferably not configured as a charger that only works if plugged into the grid.

The charger power supply is preferably a battery. The capacity of the charger power supply is larger than the capacity of the device power supply of the aerosol-generating device. Preferably, the capacity of the charger power supply is larger than the capacity of the device power supply of the aerosol-generating device by a factor of at least 1.5, preferably by a factor of at least 2.0, more preferably by a factor of at least 3.0, most preferably by a factor of at least 4.0.

The cover may have a diameter that is larger than the diameter of the aerosol-generating device. As a consequence, the cover may allow insertion of the aerosol-generating device into the opening of the cover. At the same time, the cover can cover the cavity of the charger, when the aerosol-generating device has been inserted into the cavity.

The diameter of the opening may correspond to or be slightly larger than the diameter of the aerosol-generating device. The aerosol-generating device may thus optimally be inserted into the opening of the charger.

In the first position of the cover, the opening of the cover may be aligned with the cavity of the charger. Hence, the aerosol-generating device can be inserted into the cavity via the opening of the cover in the first position of the cover.

In the second position of the cover, the cavity may be closed by the cover. The aerosol-generating device may be held in the cavity by the cover in the second position of the cover.

The cavity may be essentially sealed from the ambient environment by the cover at least at a proximal end of the cavity when the cover is in the second position. The cavity may be essentially sealed from the ambient environment by the cover when the cover is in the second position. The cavity may be hermetically sealed from the ambient environment by the cover at least at a proximal end of the cavity when the cover is in the second position. The cavity may be hermetically sealed from the ambient environment by the cover when the cover is in the second position.

The cover may be configured such that the aerosol-generating device is biased or pushed towards a distal end of the cavity by the cover, when the aerosol-generating device is received in the cavity and when the cover is in the second position.

The cover may be hollow. The cover may be a sphere, wherein the sphere has the opening. The cover may be a complete hollow sphere apart from the opening.

A proximal portion of the cover may face the ambient environment. This may enable a user to manually operate the cover. The proximal end of the cover may form the proximal end of the charger. A user may manipulate the proximal portion of the cover by sliding a digit over the proximal portion of the cover thereby rotating the cover from the first position to the second position and vice versa.

Side portions of the cover may be held by the charger. The side portions of the cover may be held by proximal portions of the charger.

The cover may be mounted in the charger. The mounting area of the charger may be spherical. The cover may be rotatably mounted in the charger. The cover may be arranged or mounted at a proximal portion of the charger.

The holder may have a slit. The slit—in the second position of the cover—may be arranged such that the aerosol-generating device may be received in the cavity with an aerosol-generating article in the device. In this configuration, it is enabled to receive the aerosol-generating device in the cavity without removing an aerosol-generating article from the aerosol-generating device.

The slit may be different from the opening. The slit may be provided in addition to the opening. The opening may be dimensioned to enable insertion of the aerosol-generating device into and through the cover. The slit may be a dimensioned to enable an aerosol-generating article to fit into the slit.

The opening may be configured as a primary opening with a diameter corresponding to or being slightly larger than the diameter of the aerosol-generating device.

The slit may be configured as a secondary opening with a diameter corresponding to or be slightly larger than the diameter of the aerosol-generating article.

The diameter of the slit may be smaller than the diameter of the aerosol-generating device.

A diameter of the slit may be smaller than a diameter of the opening.

The slit may be arranged abutting the opening.

The opening may be configured as a through-hole. The opening may have a first proximal opening and a second distal opening. The first proximal opening of the cover may be arranged at a proximal end face of the cover and the second distal opening of the cover may be arranged at a distal end face of the cover.

The slit may connect the first proximal opening and the second distal opening. The slit may be arranged between the first proximal opening and the second distal opening.

This arrangement may enable—as a first step—to arrange the cover in the first position and to insert the aerosol-generating device through the opening of the cover and into the cavity of the charger. Due to the large diameter of the opening of the cover, an aerosol-generating article may remain inserted in the aerosol-generating device during this first step. As a second step, the cover may be rotated from the first position to the second position. This rotation may be performed such that the slit is pushed over the aerosol-generating article. In this second position of the cover, the aerosol-generating article may partly stick into the cover through the slit of the cover. Due to the diameter of the slit being smaller than the diameter of the aerosol-generating device, the aerosol-generating device may still be securely held in the cavity of the charger while the aerosol-generating article penetrates through the slit.

The mobile charger may further comprise an actuating mechanism. The actuating mechanism may be configured to rotate the cover from the first position to the second position or from the second position to the first position, or both from the first position to the second position and from the second position to the first position.

The actuating mechanism may comprise a slider.

The actuating mechanism may be arranged at a housing of the charger. The actuating mechanism may be arranged on a periphery of the housing of the charger. The actuating mechanism may be arranged to be operated by a user, particularly by a digit of the user. The actuating mechanism may be arranged to be operated by a single digit of the user.

The actuating mechanism may be configured to rotate the cover during actuation of the actuating mechanism.

The actuating mechanism may be mechanically connected with the cover. The actuating mechanism may be mechanically attached to the cover. The movement of the actuating mechanism may be translated to the cover by any known means, particularly by gears or a belt or a chain. Alternatively, the actuating mechanism may be automatically activated by a motor such as an electric motor, most preferably a linear electric motor. The automatic activation may be triggered by insertion of the aerosol-generating device into the cavity of the charger and detection of the insertion of the aerosol-generating device by the electric circuitry of the charger.

The mobile charger may further comprise a biasing means. The biasing means may be arranged in the cavity for biasing the aerosol-generating device towards the cover, when the aerosol-generating device is received in the cavity.

The biasing means may be configured as a spring. The biasing means may be arranged at a base of the cavity. The base of the cavity may be arranged at a distal portion of the cavity. The biasing means may be mounted at the base of the cavity.

The mobile charger may further comprise a first electrode and a second electrode. The first electrode and the second electrode may be electrically connected with the charger power supply. The first electrode and the second electrode may be arranged at a base of the cavity.

The aerosol-generating device may comprise a corresponding first device electrode and a corresponding second device electrode.

When the aerosol-generating device is received in the cavity, and electrical connection may be established between the first electrode of the charger and the first device electrode of the aerosol-generating device and the second electrode of the charger and the second device electrode of the aerosol-generating device respectively.

The first electrode of the charger may be configured as a central electrode. The first device electrode of the aerosol-generating device may be configured as a central electrode. The second electrode of the charger may be configured as a ring-shaped electrode surrounding the first electrode. The second device electrode of the aerosol-generating device may be configured as a ring-shaped electrode surrounding the first device electrode. Alternatively, the second electrode of the charger may be configured as a central electrode. The second device electrode of the aerosol-generating device may be configured as a central electrode. The first electrode of the charger may be configured as a ring-shaped electrode surrounding the second electrode. The first device electrode of the aerosol-generating device may be configured as a ring-shaped electrode surrounding the second device electrode. This arrangement may facilitate establishing a secure electrical connection between the aerosol-generating device and the charger independent of the orientation of the aerosol-generating device in the cavity.

The cover may be dimensioned to securely press the aerosol-generating device into the cavity, when the aerosol-generating device is held in the cavity and when the aerosol-generating device is received in the cavity and when the holder is in the second position.

The cover may bias the aerosol-generating device in a distal direction into the cavity, when the cover is in the second position and when the aerosol-generating device is received in the cavity of the charger.

The cover may be at least partly elastic. The cover may be fully elastic. An elastic configuration of the cover may facilitate the biasing action of the aerosol-generating device via the cover.

The opening of the cover may run centrally through the cover.

The cavity of the charger may have a central longitudinal axis. The opening of the cover may define a central longitudinal axis through the cover. In the first position of the cover, the central longitudinal axis of the cavity may be identical to the central longitudinal axis of the cover. In the second position of the cover, the central longitudinal axis of the cover may be perpendicular to the central longitudinal axis of the cover.

The cavity of the charger may have a cylindrical shape. The cavity of the charger may be hollow. The cavity of the charger may be open at the proximal end. The cavity of the charger may be closed at the distal end, preferably by the base of the cavity.

The cross-sectional shape of the cavity of the charger may correspond to the cross-sectional shape of the aerosol-generating device.

The invention further relates to a system comprising the mobile charger as described herein and an aerosol-generating device. The aerosol-generating device may comprise a device power supply. The mobile charger may be configured to recharge the device power supply via the charger power supply, when the aerosol-generating device is received in the cavity of the mobile charger.

The invention further relates to a system comprising the mobile charger as described herein and an aerosol-generating device. The aerosol-generating device comprises a device power supply. The mobile charger is configured to recharge the device power supply via the charger power supply, when the aerosol-generating device is received in the cavity of the mobile charger.

The invention further relates to an aerosol-generating system comprising the system as described herein and an aerosol-generating article comprising aerosol-forming substrate.

The cavity of the aerosol-generating device may have an open end into which the aerosol-generating article is inserted. The open end may be a proximal end. The cavity may have a closed end opposite the open end. The closed end may be the base of the cavity. The closed end may be closed except for the provision of air apertures arranged in the base. The base of the cavity may be flat. The base of the cavity may be circular. The base of the cavity may be arranged upstream of the cavity. The open end may be arranged downstream of the cavity. The cavity may have an elongate extension. The cavity may have a longitudinal central axis. A longitudinal direction may be the direction extending between the open and closed ends along the longitudinal central axis. The longitudinal central axis of the cavity may be parallel to the longitudinal axis of the aerosol-generating device.

The cavity of the aerosol-generating device may be configured as a heating chamber. The cavity may have a cylindrical shape. The cavity may have a hollow cylindrical shape. The cavity may have a shape corresponding to the shape of the aerosol-generating article to be received in the cavity. The cavity may have a circular cross-section. The cavity may have an elliptical or rectangular cross-section. The cavity may have an inner diameter corresponding to the outer diameter of the aerosol-generating article.

An airflow channel may run through the cavity of the aerosol-generating device. Ambient air may be drawn into the aerosol-generating device, into the cavity and towards the user through the airflow channel. Downstream of the cavity, a mouthpiece may be arranged or a user may directly draw on the aerosol-generating article. The airflow channel may extend through the mouthpiece.

As used herein with reference to the present invention, the term ‘smoking’ with reference to a device, article, system, substrate, or otherwise does not refer to conventional smoking in which an aerosol-forming substrate is fully or at least partially combusted. The aerosol-generating device of the present invention is arranged to heat the aerosol-forming substrate to a temperature below a combustion temperature of the aerosol-forming substrate, but at or above a temperature at which one or more volatile compounds of the aerosol-forming substrate are released to form an inhalable aerosol.

The aerosol-generating device may comprise electric circuitry. The electric circuitry of the aerosol-generating device may comprise a microprocessor, which may be a programmable microprocessor. The microprocessor may be part of a controller. The electric circuitry may comprise further electronic components. The electric circuitry may be configured to regulate a supply of power to the heating element. Power may be supplied to the heating element continuously following activation of the aerosol-generating device or may be supplied intermittently, such as on a puff-by-puff basis. The power may be supplied to the heating element in the form of pulses of electrical current. The electric circuitry may be configured to monitor the electrical resistance of the heating element, and preferably to control the supply of power to the heating element dependent on the electrical resistance of the heating element.

The charger may comprise electric circuitry. The electric circuitry of the charger may comprise a microprocessor, which may be a programmable microprocessor. The microprocessor may be part of a controller. The electric circuitry may comprise further electronic components. The electric circuitry may be configured to regulate a supply of power from the charger power supply to the device power supply. Power may be supplied to the device power supply, when the aerosol-generating device is received in the cavity of the charger. The charger may periodically check if the aerosol-generating device is received in the cavity. Alternatively, moving the cover from the first position to the second position may lead to a checking—by the charger—if the aerosol-generating device is received in the cavity of the charger.

In one embodiment, one or both of the charger power supply and the device power supply is a Lithium-ion battery. Alternatively, one or both of the charger power supply and the device power supply may be a Nickel-metal hydride battery, a Nickel cadmium battery, or a Lithium based battery, for example a Lithium-Cobalt, a Lithium-Iron-Phosphate, Lithium Titanate or a Lithium-Polymer battery. As an alternative, one or both of the charger power supply and the device power supply may be another form of charge storage device such as a capacitor. One or both of the charger power supply and the device power supply may require recharging and may have a capacity that enables to store enough energy for one or more usage experiences; for example, the device power supply may have sufficient capacity to continuously generate aerosol for a period of around six minutes or for a period of a multiple of six minutes. In another example, the device power supply may have sufficient capacity to provide a predetermined number of puffs or discrete activations of the heating element. The charger power supply may have sufficient capacity to recharge the device power supply at least once, preferably at least twice, more preferably at least three times, most preferably at least four times.

As used herein, the terms ‘upstream’, ‘downstream’, ‘proximal’ and ‘distal’ are used to describe the relative positions of components, or portions of components, of the aerosol-generating device or the charger respectively in relation to the direction in which a user draws on the aerosol-generating device during use thereof or in relation to the direction in which a user inserts the aerosol-generating device into the cavity of the charger respectively.

As used herein, an ‘aerosol-generating device’ relates to a device that interacts with an aerosol-forming substrate to generate an aerosol. The aerosol-forming substrate may be part of an aerosol-generating article, for example part of a smoking article. An aerosol-generating device may be a smoking device that interacts with an aerosol-forming substrate of an aerosol-generating article to generate an aerosol that is directly inhalable into a user's lungs thorough the user's mouth. An aerosol-generating device may be a holder. The device may be an electrically heated smoking device. The aerosol-generating device may comprise a housing, electric circuitry, a power supply, a heating chamber and a heating element.

The aerosol-generating substrate may comprise an aerosol-former. The aerosol-generating substrate preferably comprises homogenised tobacco material, an aerosol-former and water. Providing homogenised tobacco material may improve aerosol generation, the nicotine content and the flavour profile of the aerosol generated during heating of the aerosol-generating article. Specifically, the process of making homogenised tobacco involves grinding tobacco leaf, which more effectively enables the release of nicotine and flavours upon heating.

As used herein, the term ‘aerosol-generating article’ refers to an article comprising an aerosol-forming substrate that is capable of releasing volatile compounds that can form an aerosol. For example, an aerosol-generating article may be a smoking article that generates an aerosol that is directly inhalable into a user's lungs through the user's mouth. An aerosol-generating article may be disposable.

In any of the aspects of the disclosure, the heating element may comprise an electrically resistive material. Suitable electrically resistive materials include but are not limited to: semiconductors such as doped ceramics, electrically “conductive” ceramics (such as, for example, molybdenum disilicide), carbon, graphite, metals, metal alloys and composite materials made of a ceramic material and a metallic material. Such composite materials may comprise doped or undoped ceramics. Examples of suitable doped ceramics include doped silicon carbides. Examples of suitable metals include titanium, zirconium, tantalum platinum, gold and silver. Examples of suitable metal alloys include stainless steel, nickel-, cobalt-, chromium-, aluminium- titanium- zirconium-, hafnium-, niobium-, molybdenum-, tantalum-, tungsten-, tin-, gallium-, manganese-, gold- and iron-containing alloys, and super-alloys based on nickel, iron, cobalt, stainless steel, Timetal® and iron-manganese-aluminium based alloys. In composite materials, the electrically resistive material may optionally be embedded in, encapsulated or coated with an insulating material or vice-versa, depending on the kinetics of energy transfer and the external physicochemical properties required.

As an alternative to an electrically resistive heating element, the heating element may be configured as an induction heating element. The induction heating element may comprise an induction coil and a susceptor. In general, a susceptor is a material that is capable of generating heat, when penetrated by an alternating magnetic field. When located in an alternating magnetic field. If the susceptor is conductive, then typically eddy currents are induced by the alternating magnetic field. If the susceptor is magnetic, then typically another effect that contributes to the heating is commonly referred to hysteresis losses. Hysteresis losses occur mainly due to the movement of the magnetic domain blocks within the susceptor, because the magnetic orientation of these will align with the magnetic induction field, which alternates. Another effect contributing to the hysteresis loss is when the magnetic domains will grow or shrink within the susceptor. Commonly all these changes in the susceptor that happen on a nano-scale or below are referred to as “hysteresis losses”, because they produce heat in the susceptor. Hence, if the susceptor is both magnetic and electrically conductive, both hysteresis losses and the generation of eddy currents will contribute to the heating of the susceptor. If the susceptor is magnetic, but not conductive, then hysteresis losses will be the only means by which the susceptor will heat, when penetrated by an alternating magnetic field. According to the invention, the susceptor may be electrically conductive or magnetic or both electrically conductive and magnetic. An alternating magnetic field generated by one or several induction coils heat the susceptor, which then transfers the heat to the aerosol-forming substrate, such that an aerosol is formed. The heat transfer may be mainly by conduction of heat. Such a transfer of heat is best, if the susceptor is in close thermal contact with the aerosol-forming substrate.

Below, there is provided a non-exhaustive list of non-limiting examples. Any one or more of the features of these examples may be combined with any one or more features of another example, embodiment, or aspect described herein.

Ex1: A mobile charger for an aerosol-generating device, the mobile charger comprising:
a cavity for receiving the aerosol-generating device,
a charger power supply for recharging the aerosol-generating device, when the aerosol-generating device is received in the cavity, and
a cover for holding the aerosol-generating device in the cavity, when the aerosol-generating device is received in the cavity,
wherein the cover is at least partly spherical, wherein the cover has an opening, wherein the opening is dimensioned such that the aerosol-generating device fits through the opening, wherein the cover is rotatable between a first position and a second position, wherein the opening is aligned with a longitudinal axis of the cavity in the first position of the cover, and wherein the aerosol-generating device is held in the cavity when the aerosol-generating device is received in the cavity and when the holder is in the second position.

Ex2: The mobile charger according to Ex1, wherein the cover is hollow.

Ex3: The mobile charger according to any of the preceding examples, wherein the holder has a slit.

Ex4: The mobile charger according to Ex3, wherein the slit is different from the opening.

Ex5: The mobile charger according to Ex3 or Ex4, wherein a diameter of the slit is smaller than a diameter of the opening.

Ex6: The mobile charger according to any of Ex3 to Ex5, wherein the slit is arranged abutting the opening.

Ex7: The mobile charger according to any of the preceding examples, wherein the mobile charger further comprises an actuating mechanism, wherein the actuating mechanism is configured to rotate the cover one or both of from the first position to the second position and from the second position to the first position.

Ex8: The mobile charger according to Ex7, wherein the actuating mechanism comprises a slider.

Ex9: The mobile charger according to any of the preceding examples, wherein the mobile charger further comprises a biasing means, wherein the biasing means is arranged in the cavity for biasing the aerosol-generating device towards the cover, when the aerosol-generating device is received in the cavity.

Ex10: The mobile charger according to any of the preceding examples, wherein the mobile charger further comprises a first electrode, wherein the first electrode is electrically connected with the charger power supply, and wherein the first electrode is arranged at a base of the cavity.

Ex11: The mobile charger according to any of the preceding examples, wherein the mobile charger further comprises a second electrode, wherein the second electrode is electrically connected with the charger power supply, and wherein the second electrode is arranged at the cover.

Ex12: The mobile charger according to Ex11, wherein the second electrode is arranged to electrically contact the aerosol-generating article, when the cover is in the second position.

Ex13: The mobile charger according to any of Ex1 to Ex9, wherein the mobile charger further comprises a first electrode and a second electrode, wherein the first electrode and the second electrode are electrically connected with the charger power supply, and wherein the first electrode and the second electrode are arranged at a base of the cavity.

Ex14: The mobile charger according to any of the preceding examples, wherein the charger power supply is configured as a charger battery.

Ex15: The mobile charger according to any of the preceding examples, wherein the cover is dimensioned to securely press the aerosol-generating device into the cavity, when the aerosol-generating device is held in the cavity when the aerosol-generating device is received in the cavity and when the holder is in the second position.

Ex16: The mobile charger according to any of the preceding examples, wherein the cover is at least partly elastic, preferably wherein the cover is fully elastic.

Ex17: The mobile charger according to any of the preceding examples, wherein the opening is configured as a through-hole.

Ex18: The mobile charger according to Ex17, wherein the through-hole is arranged such that the aerosol-generating article can be pushed fully through the cover.

Ex19: The mobile charger according to Ex17 or Ex18, wherein the slit of any of examples 3 to 6 is arranged to connect opposite openings of the through-hole.

Ex20: The mobile charger according to any of the preceding examples, wherein the mobile charger has a cylindrical shape.

Ex21: The mobile charger according to any of the preceding examples, wherein the mobile charger further comprises at least one magnet arranged in the cavity, preferably arranged at a base of the cavity.

Ex22: The mobile charger according to any of the preceding examples, wherein the mobile charger further comprises a retractable screen.

Ex23: The mobile charger according to Ex22, wherein the retractable screen is flexible.

Ex24: The mobile charger according to Ex22 or Ex23, wherein the retractable screen is arranged to be retracted into a mobile charger housing.

Ex25: The mobile charger according to any of Ex22 to Ex24, wherein the retractable screen is configured as a touch screen.

Ex26: The mobile charger according to any of the preceding examples, wherein the mobile charger further comprises a display. The display may be flexible. The display may be rolled around the charger. The charger may have a wrap-around closing mechanism. The wrap-around closing mechanism may hold the holder inside the cavity of the charger for charging. The wrap-around closing mechanism may wrap around the holder. The wrap-around closing mechanism may be magnetically fastened to the side of the charger. The wrap-around closing mechanism may be provided with the display. The wrap-around closing mechanism may have a double functionality, namely a display functionality and a holding functionality.

Ex27: The mobile charger according to any of the preceding examples, wherein the mobile charger further comprises a camera.

Ex28: The mobile charger according to any of the preceding examples, wherein the mobile charger further comprises a grip.

Ex29: The mobile charger according to Ex28, wherein the grip is configured an ergonomic grip.

Ex30: A system comprising the mobile charger of any of the preceding examples and an aerosol-generating device, wherein the aerosol-generating device comprises a device power supply, and wherein the mobile charger is configured to recharge the device power supply via the charger power supply, when the aerosol-generating device is received in the cavity of the mobile charger.

Ex31: An aerosol-generating system comprising the system of Ex30 and an aerosol-generating article comprising aerosol-forming substrate.

Features described in relation to one embodiment may equally be applied to other embodiments of the invention.

The invention will be further described, by way of example only, with reference to the accompanying drawings in which:

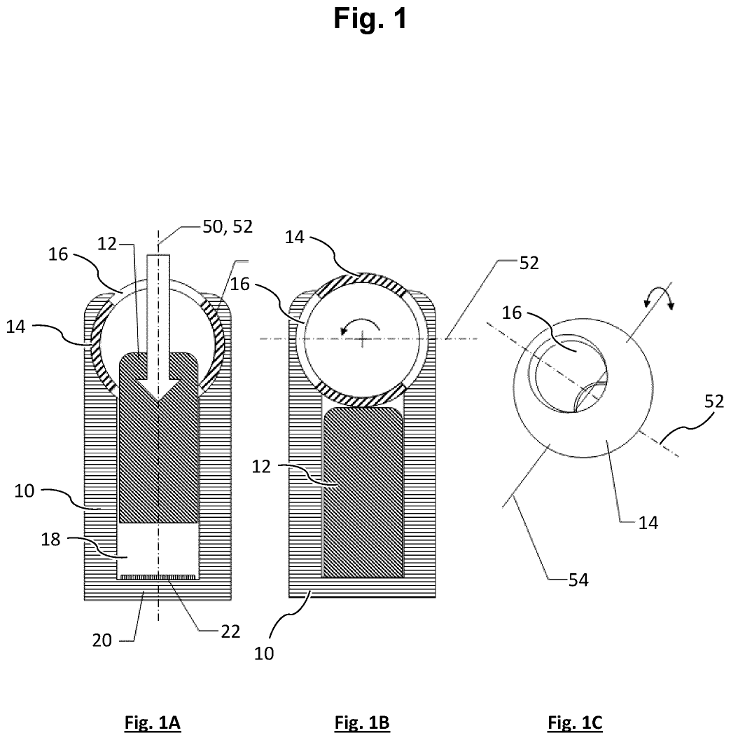

FIGS. 1A-1C show a mobile charger for an aerosol-generating device and the aerosol-generating device;

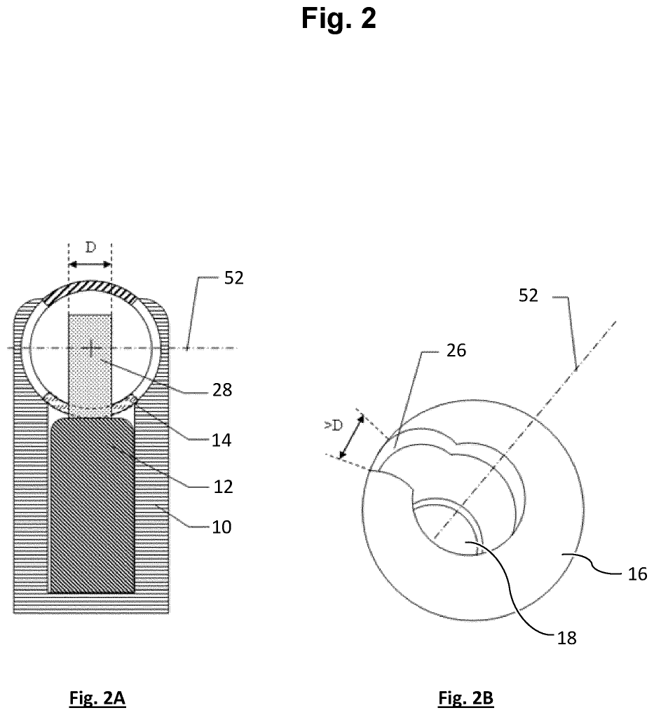

FIGS. 2A-2B show a different configuration of the mobile charger;

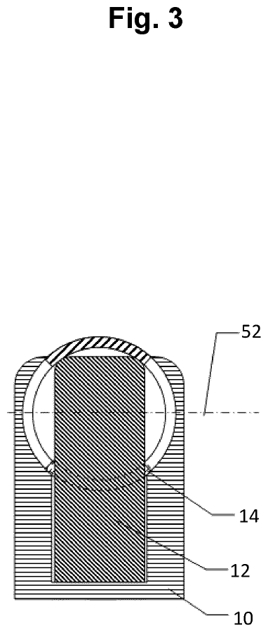

FIG. 3 shows a different configuration of the mobile charger;

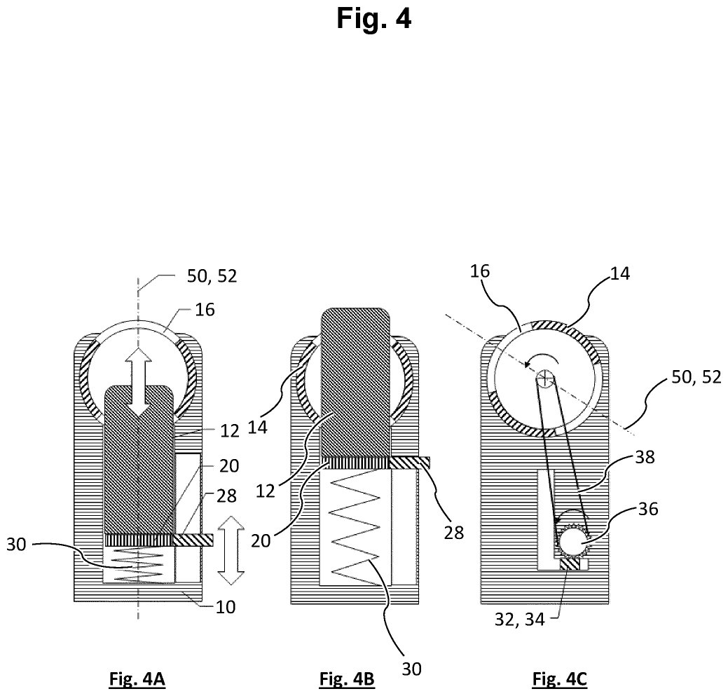

FIGS. 4A-4C show moving mechanisms of the mobile charger for moving the aerosol-generating device and actuating means for rotating a cover of the mobile charger;

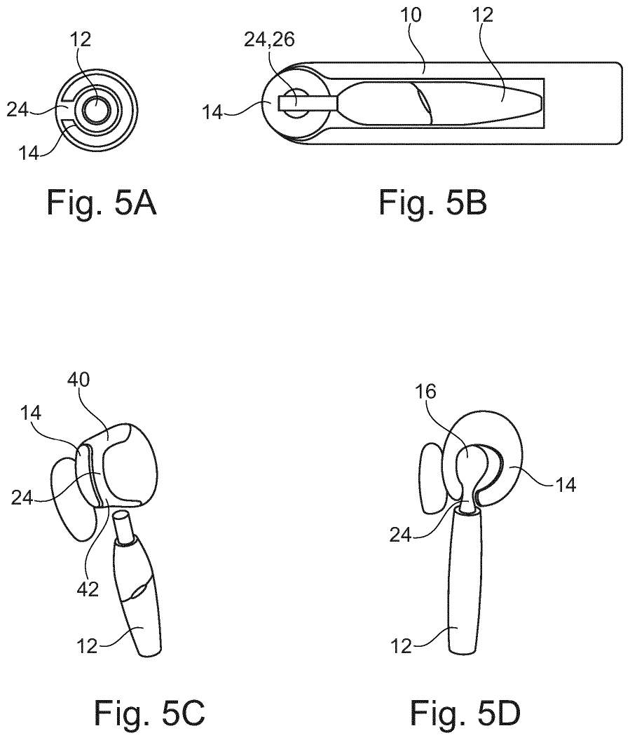

FIGS. 5A-5D show a different configuration of the mobile charger;

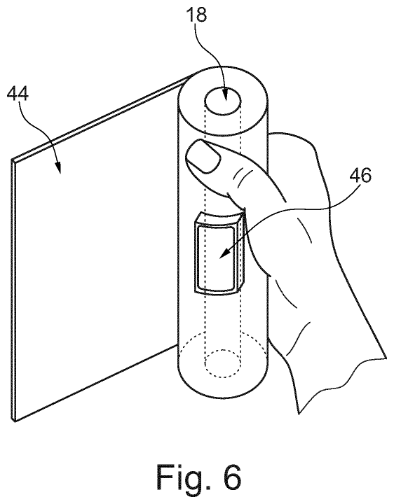

FIG. 6 shows a different configuration of the mobile charger having a retractable screen;

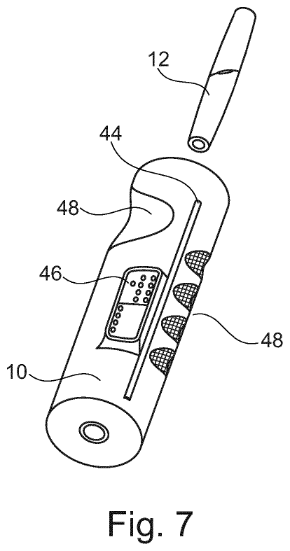

FIG. 7 shows a different configuration of the mobile charger having an ergonomic grip;

FIG. 1 shows a cross-sectional side view of a mobile charger 10. FIG. 1 further shows an aerosol-generating device 12. The aerosol-generating device 12 can be inserted into the charger 10 for recharging of the aerosol-generating device 12.

FIG. 1 further shows a cover 14 having an opening 16. The cover 14 is part of the charger 10. The opening 16 of the cover 14 is provided such that the aerosol-generating device 12 can be received by the charger 10 through the opening 16.

The charger 10 comprises a cavity 18. The aerosol-generating device 12 is inserted into the cavity 18 of the charger 10 for recharging of the aerosol-generating device 12. At a base 20 of the cavity 18, electrical contacts 22 are provided.

The cover 14 can be rotated between a first position and the second position. The first position of the cover 14 is shown in FIG. 1A. In this position, a longitudinal axis 50 of the cavity 18 is in alignment with a longitudinal axis 52 of the cover 14. As a consequence, the aerosol-generating device 12 can be pushed through the cover 14 and into the cavity 18 of the charger 10.

After the aerosol-generating device 12 has been fully inserted into the cavity 18 of the charger 10, the cover 14 is rotated into the second position. The second position of the cover 14 is shown in FIG. 1B. In this position, the aerosol-generating device 12 is securely held in the cavity 18 by means of the rotated cover 14. The cover 14 is rotated such that the proximal end of the cavity 18 is closed.

The rotation of the cover 14 into the second position biases the aerosol-generating device 12 in the direction of the base 20 of the cavity 18. The closing of the cavity 18 by means of rotating the cover 14 into the second position pushes the aerosol-generating device 12 into the cavity 18 and into secure contact with the electrical contacts 22.

FIG. 1C shows the cover 14 in isolation. The cover 14 has a spherical shape. The cover 14 has the opening 16 for pushing the aerosol-generating device 12 through the cover 14. The opening 16 is a through-hole. The cover 14 is hollow. The cover 14 can be rotated between the first and second positions. The cover 14 can be rotated around a rotational axis 54 of the cover 14. The rotational axis 54 of the cover 14 is perpendicular to the longitudinal axis 52 of the cover 14.

FIG. 2 shows a further configuration, in which the cover 14 additionally comprises a slit 24. Apart from the slit 24, the configuration of FIG. 2 is similar to the configuration of FIG. 1. The slit 24 is provided to enable insertion of the aerosol-generating device 12 into the cavity 18 of the charger 10 while an aerosol-generating article 26 is still inserted into the aerosol-generating device 12.

While the opening 16 of the cover 14 has a relatively large diameter corresponding to or being slightly larger than the diameter of the aerosol-generating device 12, the slit 24 has a smaller diameter which corresponds to or is slightly larger than the diameter of the aerosol-generating article 26.

During operation, the cover 14 is initially positioned in the first position identical to the arrangement shown in FIG. 1A. The aerosol-generating device 12 is then inserted into the cavity 18 of the charger 10 through the opening 16 of the cover 14, while the aerosol-generating article 26 is still received in the aerosol-generating device 12. The cover 14 is then rotated to the second position. The second position deviates slightly from the arrangement shown in FIG. 1, since the rotation takes place such that the aerosol-generating article 26 is slotted into the slit 24 as shown in FIG. 2A. FIG. 2B shows the cover 14 in isolation comprising the slit 24, wherein the diameter of the slit 24 corresponds to or is slightly larger than the diameter of the aerosol-generating article 26.

FIG. 3 shows an embodiment in which the aerosol-generating device 12 is not fully pushed through the cover 14 and into the cavity 18, when the aerosol-generating device 12 is inserted into the cavity 18. In this embodiment, when the cover 14 is rotated from the first position to the second position, the aerosol-generating device 12 is still at least partly arranged in the cover 14. However, the cover 14 still holds the aerosol-generating device 12 in the cavity 18 of the charger 10.

FIG. 4 shows different embodiments how to actuate the cover 14 and how to move the aerosol-generating device 12. FIG. 4A shows a moving mechanism 28 in the form of a slider for moving the aerosol-generating device 12 in and out of the cavity 18. The moving mechanism 28 shown in FIG. 4A is connected with the base 20 of the cavity 18, which in this embodiment is configured as a movable base 20. FIG. 4A shows a positioning of the aerosol-generating device 12 such that the aerosol-generating device 12 is nearly fully inserted into the cavity 18, while FIG. 4B shows the moving mechanism 28 in a position such that the aerosol-generating device 12 can be gripped by a user and removed from the cavity 18 through the opening 16 of the cover 14. FIGS. 4A and 4B further show a biasing means 30 in the form of a spring for biasing the aerosol-generating device 12 towards the cover 14.

FIG. 4C shows an actuating means 32 for moving the cover 14. The actuating means 32 comprises an actuating slider 34, a gear wheel 36 and the belt 38. For actuating the actuating means 32, the actuating slider 34 is moved leading, via the gear wheel 36 and the belt 38, to a rotation of the cover 14.

Preferably, as shown in FIGS. 4A to 4C, the moving mechanism 28 and the actuating means 32 are integrated in a signal mechanism. In FIG. 4C, the vertical movement of the actuating slider 34 corresponds to the movement of the moving mechanism 28 of FIGS. 4A and 4B. The horizontal movement of the actuating slider 34 in FIG. 4C corresponds to operating the actuating means 32 and thereby rotating the cover. A user thus can vertically operate the slider 34 and thereby move the aerosol-generating device 12 into the cavity 18 of the charger 10. Subsequently, the user can move the slider 34 horizontally to close the cover 12, that is, to move the cover 12 from the first position to the second position. Instead of manually operating the slider 34, an electric motor can be used for that purpose. Operation of the electric motor can be controlled by the input of the user, exemplarily via the retractable screen 44 described in below FIGS. 6 and 7.

FIG. 5 shows different perspectives of the cover 14 having a slit 24. In the embodiment of FIG. 5, the slit 24 fully connects the opening 16 of the cover 14. The slit 24 connects a first proximal opening 40 with a second distal opening 42 of the opening of the cover 14. FIG. 5A shows a top view. FIG. 5B shows a cross-sectional side view of the cover 14, the charger 10, the aerosol-generating device 12 and the aerosol-generating article 26. FIGS. 5C and 5D show rotation of the cover 14 from the first position to the second position. In the first position, the aerosol-generating device 12 can be pushed through the cover 14 and into the cavity 18 of the charger 10. In FIG. 5D, the cover 14 is rotated into the second position and the aerosol-generating device 12 is securely held in the cavity 18 of the charger 10 while an aerosol-generating article 26 can still be received in the aerosol-generating device 12.

FIG. 6 shows a retractable screen 44 that can be incorporated into the housing of the charger 10. The retractable screen 44 can be used to display 46 information to a user or to enable a communication interface between the user and the charger 10.

FIG. 6 further shows a display 46 that can be used to notify the user of the operational status of the charger 10. For example, the display 46 can show the user the charging state of the aerosol-generating device 12. The display 46 can further show the user the charging level of the charger 10 power supply.

FIG. 7 shows an ergonomic grip 48 of the charger 10. Further, FIG. 7 shows the retractable screen 44 in the retracted state.

1.-15. (canceled)

16. A mobile charger for an aerosol-generating device, the mobile charger comprising:
a cavity configured to receive the aerosol-generating device;
a charger power supply configured to recharge the aerosol-generating device when the aerosol-generating device is received in the cavity; and
a cover configured to hold the aerosol-generating device in the cavity when the aerosol-generating device is received in the cavity,
wherein the cover is at least partly spherical,
wherein the cover has an opening,
wherein the opening is dimensioned such that the aerosol-generating device fits through the opening,
wherein the cover is rotatable between a first position and a second position,
wherein the opening is aligned with a longitudinal axis of the cavity in the first position of the cover, and
wherein the aerosol-generating device is held in the cavity when the aerosol-generating device is received in the cavity and when the holder is in the second position.

17. The mobile charger according to claim 16, wherein the cover is hollow.

18. The mobile charger according to claim 16, wherein the holder has a slit.

19. The mobile charger according to claim 18, wherein the slit is different from the opening.

20. The mobile charger according to claim 18, wherein a diameter of the slit is smaller than a diameter of the opening.

21. The mobile charger according to claim 18, wherein the slit is arranged abutting the opening.

22. The mobile charger according to claim 18,
wherein the mobile charger further comprises an actuating mechanism, and
wherein the actuating mechanism is configured to rotate the cover one or both of from the first position to the second position and from the second position to the first position.

23. The mobile charger according to claim 22, wherein the actuating mechanism comprises a slider.

24. The mobile charger according to claim 16,
wherein the mobile charger further comprises a biasing means, and
wherein the biasing means is arranged in the cavity for biasing the aerosol-generating device towards the cover, when the aerosol-generating device is received in the cavity.

25. The mobile charger according to claim 16,
wherein the mobile charger further comprises a first electrode and a second electrode,
wherein the first electrode and the second electrode are electrically connected with the charger power supply, and
wherein the first electrode and the second electrode are arranged at a base of the cavity.

26. The mobile charger according to claim 16, wherein the cover is dimensioned to securely press the aerosol-generating device into the cavity, when the aerosol-generating device is held in the cavity, when the aerosol-generating device is received in the cavity, and when the holder is in the second position.

27. The mobile charger according to claim 16, wherein the cover is at least partly elastic.

28. The mobile charger according to claim 16, wherein the cover is fully elastic.

29. The mobile charger according to claim 16, wherein the opening is configured as a through-hole.

30. A system comprising the mobile charger according to claim 16 and an aerosol-generating device, wherein the aerosol-generating device comprises a device power supply, and wherein the mobile charger is configured to recharge the device power supply via the charger power supply when the aerosol-generating device is received in the cavity of the mobile charger.

31. An aerosol-generating system comprising the system of claim 30 and an aerosol-generating article comprising aerosol-forming substrate.
